(19) United States
(12) Patent Application Publication
(10) Pub. No.: US 2010/0041852 A1
(43) Pub. Date: Feb. 18, 2010

(54) METHOD FOR PRODUCING SILYL TELECHELIC POLYMERS

(75) Inventors: Sven Balk, Frankfurt (DE); Gerd Loehden, Essen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/440,244

(22) PCT Filed: Jun. 26, 2007
(86) PCT No.: PCT/EP07/56359

§ 371 Date: Mar. 6, 2009

(30) Foreign Application Priority Data
Oct. 10, 2006 (DE) 10 2006 048 154.2

(51) Int. Cl. C08G 77/28; C08G 77/06; C08G 77/08

(52) U.S. Cl. 528/15; 528/30; 528/19; 528/26; 528/25

(57) ABSTRACT

The present invention relates to the in situ silyl end group functionalization of polymer chains which have been prepared by means of atom transfer radical polymerization and the simultaneous removal of transition metals from polymer solutions.

### FIELD OF THE INVENTION

The present invention relates to the synthesis of polymers which have silyl end groups and have been prepared by means of atom transfer radical polymerization (referred to hereinafter as ATRP for short). A particular aspect is the preparation of silyl-telechelic polymethacrylates, polyacrylates or polystyrenes.

A very particular aspect of the present invention is that the addition of the reagent in one process step simultaneously removes the transition metal compounds from the polymer solution by means of precipitation and forms salts of the ligands coordinated beforehand to the transition metal, which in turn enables simple removal thereof.

ATRP is an important process for preparing a multitude of polymers, for example polyacrylates, polymethacrylates or polystyrenes. This type of polymerization brings one a great deal closer to the goal of tailored polymers. The ATRP method was developed in the 1990s to a crucial degree by Prof. Matyjaszewski (Matyjaszewski et al., J. Am. Chem. Soc., 1995, 117, p. 5614; WO 97/18247; Science, 1996, 272, p. 866). ATRP affords narrowly distributed (homo)polymers in the molar mass range of Mₙ=5000-120 000 g/mol. A particular advantage is that both the molecular weight and the molecular weight distribution are controllable. As a living polymerization, it also permits the controlled formation of polymer architectures, for example random copolymers or else block copolymer structures. By means of appropriate initiators, for example, unusual block copolymers and star polymers are additionally obtainable. Theoretical bases of the polymerization mechanism are explained, inter alia, in Hans Georg Elias, Makromolekuile [Macromolecules], Volume 1, 6th Edition, Weinheim 1999, p. 344.

### STATE OF THE ART

The development of a process step in ATRP in which, simultaneously, the halogen at the chain end of the polymer is removed, the transition metal is precipitated completely, the ligand is converted to an ionic form which can be removed easily and a functionalization of the chain ends with organic silyl groups can be undertaken is in no way prior art. This is already true merely for the combination of simultaneously transition metal precipitation and silyl functionalization of the chain ends.

Furthermore, the present invention, in each case alone, constitutes a significant improvement over the prior art with regard to the end group functionalization, with regard to the halogen removal and with regard to the transition metal precipitation. A combination of all three functions has not been described to date in the prior art. Hereinafter, this document is therefore restricted to the aspects of end group functionalization and silyl-functionalized ATRP products.

The ATRP process is based on a redox equilibrium between a dormant species and an active species. The active species is the growing free-radical polymer chain present only in a low concentration and a transition metal compound in a relatively high oxidation state (e.g. copper(II)). The dormant species which is preferably present is the combination of the polymer chain terminated with a halogen or a pseudohalogen and the corresponding transition metal compound in a relatively low oxidation state (e.g. copper (I)). This is true both for ATRP in the actual form, which is initiated with (pseudo)halogen-substituted initiators, and for reverse ATRP which is described below, in which the halogen is not bound to the polymer chain until the equilibrium is established. The halogen atom remains on the particular chain ends after termination of the reaction irrespective of the process selected. These terminal halogen atoms may be useful in various ways. A large number of documents describe the use of such a polymer as a macroinitiator after a purification or by sequential addition of further monomer fractions to form block structures. As a representative example, reference is made to U.S. Pat. No. 5,807,937 with regard to sequential polymerization, and to U.S. Pat. No. 6,512,060 with regard to the synthesis of macroinitiators.

However, a problem is the thermal instability of such halogen-functionalized polymers, which is well known to those skilled in the art. Especially polymethacrylates or polyacrylates are found to be significantly more sensitive to depolymerization in the presence of terminal halogen atoms. A method for removing these terminal halogen atoms is therefore of great interest. One widespread process is based on the substitution of the halogens with metal alkoxides while precipitating the metal halide formed. Such a process is described, for example, in US 2005/0900632. A disadvantage of this method is the only limited availability of the metal alkoxides, their costs, and that the process can be performed in a separate process step only after a purification of the polymers. Moreover, direct functionalization with a silyl group is not possible by this route.

EP 0 976 766 and EP 1 179 567 describe a three-stage process for synthesizing silyl-terminated halogen-free polymers. After an ATRP with appropriate product purification, the substitution of the terminal halogen atoms by an unsaturated metal alkoxide is performed in a second step. After another purification of the product, the corresponding double bonds are hydrosilylated. It is readily apparent to the person skilled in the art that these three process steps are not possible without a thorough purification of the particular precursor products. Even when this process affords polymers which are very similar to the inventive polymers, these products differ by a reduced number of functionalities which can additionally be incorporated into the chain and would be disruptive either in the substitution or in the hydrosilylation. In US 2005/0113543, in one variant, an unsaturated ATRP initiator is used and, analogously to the process described above, an allyl group is transferred to the second chain end by means of an organotin compound, by substitution of the halogen atom in a second stage. The two groups, which can only be distinguished from one another easily in their chemical environment, can then readily be hydrosilylated.

The situation is similar also for other processes for substituting the terminal halogen groups: both azides (see Matyjaszewski et al., Macromol. Rapid Commun, 18, 1057-66. 1997) and phosphines (Coessens, Matyjaszewski, Macromol. Sci. Pure Appl. Chem., 36, 653-666, 1999) lead only to incomplete conversions, are toxicologically very controversial, are poorly suited to direct silyl functionalization and are expensive. Moreover, these processes are only employable in a polymer-analogous reaction after a product workup.

An alternative to the two-stage polymerization and subsequent substitution of the terminal halogen atoms for the synthesis of the prepolymers required for the hydrosilylation is so-called end capping. In this method, compounds which are incorporated by free-radical means at the chain end like monomers, but then form a new, still halogen-functionalized but polymerization-inactive chain end, are added to the polymerization solution at a time of maximum conversion. EP 1 085 027 and EP 1 024 153 describe various nonconjugated dienes as such end cappers. Octadiene in particular is listed as a particularly suitable compound for providing olefinic end groups. EP 1 158 006 also mentions cyclooctadiene as a very suitable reagent. Telechelics with two identical end groups are achievable by means of ATRP by using bifunctional initiators.

The advantage of this method is that a separate process step with preceding product purification is dispensed with, as in the case of substitution, and the chain ends are functionalized olefinically directly at the end of the polymerization. A disadvantage compared to substitution and hence also compared to the present invention is, however, that the halogen atom remains at the chain end and either would have to be removed separately by an additional process step or a higher thermal instability of the product is accepted. Moreover, this method too, like the substitution processes described above too, affords only olefinically terminated products which first have to be hydrosilylated after a complicated purification. This purification must in particular be performed exceptionally thoroughly, since the ligands required in the ATRP to solvate the transition metal compound deactivate the hydrosilylation catalysts based generally on platinum compounds—for example the Karstedt catalyst which is considered to be the standard. ATRP is particularly efficient and of economic interest, for example, in the case of use of polydentate amine ligands, as described in more detail below in this document. However, these compounds in particular quantitatively deactivate the platinum metal catalysts which are only to be used in ultrasmall concentrations, and therefore have to be removed completely from the polymer beforehand. These aspects make complete silyl functionalization of the polymers rather improbable or make the process additionally time-consuming and uneconomic. The hydrosilylation of the polymers described can be read about in EP 1 153 942 or in EP 1 498 433.

According to the invention, the terminal halogen atoms are substituted by using a mercaptan with an additional silane functionality. Only in Snijder et al. (J. of Polym. Sci.: Polym. Chem.) is such a substitution reaction on an ATRP product with a mercaptan described briefly. This substitution reaction is performed here exclusively with mercaptoethanol. An application of the process to the inventive silyl mercaptans is not described.

A further difference from the present invention is the polymer-analogous procedure. In the document described, the substitution reaction is performed only after purification of the ATRP product in a second reaction stage. This gives rise directly to a second important difference from the present invention. The inventive effect of precipitating the transition metal compounds from the ATRP solution by adding mercaptan reagents is accordingly not described at all in this document. In addition, the present invention describes, unlike the document cited, new types of tri- and pentablock copolymers functionalized on the end groups at both ends.

A great disadvantage of the binders for prior art adhesives is the high viscosity, which is relevant in the course of processing. As a result, processing of an adhesive or of a molten reactive hotmelt adhesive, in particular the application to porous substrates, is complicated significantly. In some cases, premature gelling of the adhesive formulation also occurs.

A further disadvantage is that the extractable content in the cured adhesive is quite high. Among other factors, this reduces the stability of the adhesive composition to solvents.

A further disadvantage is frequently only inadequate viscosity stability of the adhesive or of the reactive hotmelt adhesive in the melt at, for example, 130° C., which complicates processability in particular.

A further disadvantage is that the free-radically polymerized materials also comprise a relatively high proportion of low molecular weight constituents which do not take part in the crosslinking reactions and constitute formulations corresponding to the extractable constituent.

The above-described problems have been solved in WO 05/047359 to the extent that use of a controlled polymerization method, in the form of ATRP, allowed binders with very narrow molecular weight distributions to be provided, which have an only low proportion of high molecular weight constituents compared to the free-radically polymerized (meth)acrylates. These constituents bring about, in particular, an increase in the viscosity in polymer mixtures. Moreover, these polymers also comprise a significantly lower proportion of low molecular weight and hence extractable constituents. The lower proportion of such constituents increases the weathering stability, slows the product ageing and leads to a significantly improved chemical stability.

A disadvantage of the adhesives prepared according to the prior art is, however, a random distribution of the functional groups required for the later curing in the polymer chain of the binder. This leads to close-meshed crosslinking and a thus reduced elasticity of the adhesive composition. This can also result in a deterioration in the substrate binding. The advantage of the use of telechelic binders and hence of the present invention is that the later polymer networks in which one component is incorporated only via the chain end groups have exceptional flexibility. This increased flexibility with simultaneously higher stability is also of very great significance in other application sectors, for example in sealants.

Problem

It is an object of the present invention to prepare polymers by means of atom transfer radical polymerization (ATRP) which have silyl groups on more than 90% of the previously polymerization-active chain ends.

It is an additional object of the present invention to prepare polymers by means of ATRP which contain halogens or pseudohalogens only in traces, if at all. It is therefore also an object to improve the thermal stability of these polymers compared to halogenated products.

In particular, it is an object of this invention to provide polymers which, with the exception of the end groups, corresponds completely to the materials which can be prepared according to the prior art by means of ATRP. This includes, inter alia, the polymer architecture, the molecular weight and the molecular weight distribution.

Molecular weight and molecular weight distribution are understood hereinafter to mean the values of the molecular weight and the molecular weight distribution which have been determined by means of gel permeation chromatography (GPC or SEC for short).

The term “polymer architecture” hereinafter includes all polymer structures. Examples include block copolymers, star polymers, telechelics, gradient copolymers, random copolymers or comb copolymers.

In particular, it is an object of this invention to perform the silyl functionalization and the simultaneous halogen removal in a process which is simple to implement and economically viable on the industrial scale. Very particularly, it is an object to perform the functionalization without additional product workup directly at the end of the actual ATRP process in the same reaction vessel (one-pot reaction).

It is a parallel object of this invention to provide, with the same process step, simultaneously a process implementable on the industrial scale for removing transition metal complexes from polymer solutions. At the same time, the novel process should be inexpensive and rapidly performable. Furthermore, it was an object of the present invention to provide a process which can be implemented without complicated modifications to known plants suitable for solution polymerization. It was a further object, as early as after a filtration step, to realize particularly low residual concentrations of the transition metal complexes.

Solution

This object is achieved by adding suitable hydroxy-functionalized sulphur compounds after or during the termination of the polymerization. By substitution of the terminal active groups of a polymer synthesized by means of ATRP with the sulphur compound, the particular chain ends are silyl-functionalized. At the same time, the terminal halogen atoms are removed from the polymer, the transition metal coordination compound used as a catalyst is quenched and the metal is thus precipitated virtually completely. It can subsequently be removed in a simple manner by means of filtration.

In detail, the addition of mercaptans to halogen-terminated polymer chains, as are present during or at the end of an ATRP process, leads to substitution of the halogen. At the chain end of the polymer, a thioether group thus forms, as already known from free-radical polymerization with sulphur-based regulators. As an elimination product, a hydrogen halide is formed.

A very particular aspect of the present invention is that, as a result of the addition of a reagent in one process step, simultaneously, the terminal halogen atoms are removed from the polymer chains, associated with this the polymer termini are silyl-functionalized, the transition metal compounds are removed by means of precipitation and salts are formed from the ligands coordinated beforehand to the transition metal, which in turn enables simple removal of the ligands from the transition metal.

In detail, what occurs when said sulphur compound is added is probably the following: the initiators used are generally ATRP compounds which have one or more atoms or atom groups X which are free-radically transferable under the polymerization conditions of the ATRP process. When the active X group on the particular chain end of the polymer is substituted, an acid of the form X—H is released. The hydrogen halide which forms cannot be hydrolysed in organic polymerization solutions and therefore has a particularly marked reactivity which leads to protonation of the usually basic ligands described below on the transition metal compound. This quenching of the transition metal complex proceeds exceptionally rapidly and gives rise to direct precipitation of the now unmasked transition metal compounds.

The transition metal generally precipitates out in the form in which it has been used at the start of the polymerization: for example, in the case of copper, as CuBr, CuCl or Cu₂O. Under the condition that the transition metal is oxidized simultaneously, for example by introduction of air or by addition of sulphuric acid, the transition metal compound additionally precipitates out in the higher oxidation state. The inventive addition of said sulphur compounds allows the transition metal precipitation additionally to be effected virtually quantitatively, unlike this oxidation-related precipitation. For instance, it is possible, as early as after a filtration step, to realize particularly low residual concentrations of the transition metal complexes of below 5 ppm.

In order to achieve this effect, the inventive use of said sulphur compound, based on the active X group at the polymer chain end, must be effected only in an excess of, for example, 1.1 equivalents. The same applies based on ligands L: in the case of complexes in which the transition metal and the ligand are present in a ratio of 1:1, likewise only a very small excess of the sulphur compound is required to achieve complete quenching of the transition metal complex. Examples of such ligands are N,N,N′,N″,N″-pentamethyldiethylene-triamine (PMDETA), which is described below, and tris(2-aminoethyl)amine (TREN). In the case of ligands which are present in a biequivalent ratio to the transition metal in the complex, this invention can be applied only when the transition metal is used in a significant deficiency of, for example, 1:2 compared to the active X groups. An example of such a ligand is 2,2′-bipyridine.

An additional part of this invention is that the sulphur compounds used can be bonded virtually completely to the polymer chains, and that the residual sulphur fractions can be removed completely and quite simply in the filtration by means of simple modifications. In this way, products which do not have an unpleasant odor caused by the sulphur compounds are obtained.

A great advantage of the present invention is the efficient removal of the transition metal complexes from the solution. Use of the process according to the invention makes it possible to reduce the transition metal content with a filtration by at least 80%, preferably by at least 95% and most preferably by at least 99%. In particular embodiments, it is even possible by use of the process according to the invention to reduce the transition metal content by more than 99.9%.

The reagents added to the polymer solution in accordance with the invention after or during the termination of polymerization are preferably compounds which contain sulphur in organically bound form. Especially preferably, these sulphur compounds used for the precipitation of transition metal ions or transition metal complexes have SH groups and simultaneously silyl groups. Very particularly preferred organic compounds include silyl-functionalized mercaptans and/or other functionalized or else unfunctionalized compounds which have one or more thiol groups and simultaneously silyl groups.

These inventive silyl-functionalized mercaptans, or mercaptosilanes for short, are generally compounds of the form

HS—R¹—((SiR²ₒ(OR³)ₚ)_{y}(SiR²ₙ(OR³)ₘ)_{z})ₓ

where R¹ is an alkyl radical having one to 20 carbon atoms, which may be linear, cyclic or branched.

Preference is given to linear alkyl radicals R′ having one to 10 carbon atoms.

Especially preferred compounds are those in which R¹ is a divalent —CH₂—, —CH₂CH₂—or a —(CH₂)₃— radical.

x is from 1 to 10 and hence is the number of silyl groups which are bonded to the alkyl radical R¹. Preference is given to alkyl radicals where x≦3 and hence at most three silyl groups. Particular preference is given to monofunctional alkyl radicals where x=1.

R² and R³ are each alkyl radicals having one to 20 carbon atoms, which may be linear, cyclic or branched. R² and R³ are preferably each alkyl radicals having one to 20 carbon atoms.

R² and R³ may be identical to one another or different. It is also possible for both R² and R³ to be identical groups or in each case different groups in the mercaptosilane. Specifically, R² and R³ may, for example, be defined as follows: methyl, ethyl, propyl, isopropyl, n-butyl, isobutyl, tert-butyl, pentyl, cyclopentyl, hexyl, cyclohexyl, heptyl, octyl, isooctyl, ethylhexyl, nonyl, decyl, eicosyl, isobornyl, lauryl or stearyl, and also cyclopentyl, cyclohexyl or cycloalkanes substituted by one or more alkyl groups, for example methylcyclohexyl or ethylcyclohexyl.

In another embodiment, R² and/or R³ may also be hydrocarbon groups having ethereal oxygen or short polyether sequences. Such compounds are described, for example, in DE 10 2005 057 801.

In a preferred embodiment, R³ is linear alkyl radicals. In a particularly preferred embodiment, R³ is methyl and/or ethyl groups.

o and p each mean numbers from 0 to 2 which add up to 2 in the case of a divalent silyl group, add up to 1 in the case of a trivalent silyl group and add up to 0 in the case of a tetravalent silyl group. y is any number from 0 to 20. Preference is given to an embodiment where y is any number from 1 to 3—more preferably, y=0. z depends on the number of tri- or tetravalent, i.e. branching, silyl groups between R¹ and the end groups and is at least 1. Preference is given to an embodiment where z=1.

m and n each mean numbers from 0 to 3 which add up to 3. Preference is given in particular to compounds where m≧2.

The especially preferred compounds are commercially readily available compounds which have great industrial significance, for example, as adhesion promoters. The advantage of these compounds is their ready availability and their low cost. One example of such a compound is 3-mercaptopropyltrimethoxysilane, which is sold by Degussa AG under the name DYNALYSAN®-MTMO. Further available silanes are 3-mercaptopropyltriethoxysilane or 3-mercaptopropylmethyldimethoxysilane (from ABCR). Particularly reactive silanes are the so-called α-silanes. In these compounds, the mercapto group and the silane group are bonded to the same carbon atom (R¹ is thus generally —CH₂—). Corresponding silane groups of such a type are particularly reactive and can thus lead, in the later formulation, to a wide application spectrum. One example of such a compound would be mercaptomethylmethyldiethoxysilane (from ABCR).

However, the present invention cannot be restricted to these compounds. Instead, what is crucial is that the precipitants used firstly have an —SH— group or form an —SH— group in situ under the present conditions of the polymer solution. Secondly, said compound has to have a silyl group.

In the free-radical polymerization, the amount of regulators, based on the polymers to be polymerized, is usually stated to be 0.05% by weight to 5% by weight. In the present invention, the amount of the sulphur compound used is not based on the monomers but rather on the concentration of the polymerization-active chain ends in the polymer solution. Polymerization-active chain ends means the sum of dormant and active chain ends. The inventive sulphur-containing precipitants are, for this purpose, used in 1.5 molar equivalents, preferably 1.2 molar equivalents, more preferably below 1.1 molar equivalents and most preferably below 1.05 molar equivalents. The remaining residual amounts of sulphur can be removed easily by modifying the subsequent filtration step.

It is readily apparent to the person skilled in the art that the mercaptans described cannot have any further influence on the polymers when they are added to the polymer solution during or after termination of the polymerization, with the exception of the substitution reaction described. This is true especially for the width of the molecular weight distributions, the molecular weight, additional functionalities, glass transition temperature, and melting point in the case of semicrystalline polymers and polymer architectures.

Moreover, it is readily apparent to the person skilled in the art that a corresponding process which is based, in apparatus terms, exclusively on a filtration of the polymer solution can be implemented easily in an industrial-scale process without any great modifications to existing solution polymerization plants.

A further advantage of the present invention is that the reduction to one filtration step or a maximum of two filtration steps allows a very rapid workup of the polymer solution compared to many established systems.

In addition, the substitution, the precipitation and the subsequent filtration are effected at a temperature in the range between 0° C. and 120° C., process parameters within a common range.

To reduce the last traces of sulphur compounds, adsorbents or adsorbent mixtures can be used. This can be effected in parallel or in successive workup steps. The adsorbents are known from the prior art, preferably selected from the group of silica and/or aluminum oxide, organic polyacids and activated carbon (e.g. Norit SX plus from Norit).

The removal of the activated carbon can also be effected in a separate filtration step or in a filtration step simultaneous with the transition metal removal. In a particularly efficient variant, the activated carbon is not added to the polymer solution as a solid, but rather the filtration is effected by means of filters laden with activated carbon, which are commercially available (e.g. AKS 5 from Pall Seitz Schenk) . It is also possible to use a combination of the addition of the above-described acidic assistants and activated carbon, or of the addition of the above-described assistants and filtration through filters laden with activated carbon.

The present invention relates to end group functionalization of polymers with silyl groups, the removal of the terminal halogen atoms and of the transition metal complexes from all polymer solutions prepared by means of ATRP processes. The possibilities which arise from the ATRP will be outlined briefly hereinafter. However, these enumerations are not capable of describing ATRP and hence the present invention in a restrictive manner. Instead, they serve to indicate the great significance and various possible uses of ATRP and hence also of the present invention for the workup of corresponding ATRP products.

The monomers polymerizable by means of ATRP are sufficiently well known. A few examples are listed below without restricting the present invention in any way. The notation “(meth)acrylate” describes the esters of (meth)acrylic acid and here means both methacrylate, for example methyl methacrylate, ethyl methacrylate, etc., and acrylate, for example methyl acrylate, ethyl acrylate, etc., and mixtures of the two.

Monomers which are polymerized are selected from the group of the (meth)acrylates, for example alkyl (meth)acrylates of straight-chain, branched or cycloaliphatic alcohols having 1 to 40 carbon atoms, for example methyl (meth)acrylate, ethyl (meth)acrylate, n-butyl (meth)acrylate, i-butyl (meth)acrylate, t-butyl (meth)acrylate, pentyl (meth)acrylate, 2-ethyl-hexyl (meth)acrylate, stearyl (meth)acrylate, lauryl (meth)acrylate, cyclohexyl (meth)acrylate, isobornyl (meth)acrylate; aryl (meth)acrylates, for example benzyl (meth)acrylate or phenyl (meth)acrylate, each of which may be unsubstituted or have mono- to tetra-substituted aryl radicals; other aromatically substituted (meth)acrylates, for example naphthyl (meth)acrylate; mono(meth)acrylates of ethers, polyethylene glycols, polypropylene glycols or mixtures thereof having 5-80 carbon atoms, for example tetrahydrofurfuryl methacrylate, methoxy(m)ethoxyethyl methacrylate, 1-butoxypropyl methacrylate, cyclohexyloxymethyl methacrylate, benzyloxymethyl methacrylate, furfuryl methacrylate, 2-butoxyethyl methacrylate, 2-ethoxyethyl methacrylate, allyloxymethyl methacrylate, 1-ethoxybutyl methacrylate, 1-ethoxyethyl methacrylate, ethoxymethyl methacrylate, poly(ethylene glycol) methyl ether (meth)acrylate and poly(propylene glycol) methyl ether (meth)acrylate. The monomer selection may also include particular hydroxy-functionalized and/or amino-functionalized and/or mercapto-functionalized and/or olefinically functionalized acrylates or methacrylates, for example allyl methacrylate or hydroxyethyl methacrylate.

In addition to the (meth)acrylates listed above, the compositions to be polymerized may also consist of other unsaturated monomers or comprise them. These include 1-alkenes such as 1-hexene, 1-heptene, branched alkenes, for example vinylcyclohexene, 3,3-dimethyl-1-propene, 3-methyl-1-diisobutylene, 4-methyl-1-pentene, acrylonitrile, vinyl esters, for example vinyl acetate, in particular styrene, substituted styrenes having an alkyl substituent on the vinyl group, for example α-methylstyrene and α-ethylstyrene, substituted styrenes having one or more alkyl substituents on the ring, such as vinyltoluene and p-methylstyrene, halogenated styrenes, for example monochlorostyrenes, dichlorostyrenes, tribromostyrenes and tetrabromostyrenes; heterocyclic compounds such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, 9-vinylcarbazole, 3-vinylcarbazole, 4-vinylcarbazole, 2-methyl-1-vinylimidazole, vinyl-oxolane, vinylfuran, vinylthiophene, vinylthiolane, vinylthiazoles, vinyloxazoles and isoprenyl ethers; maleic acid derivatives, for example maleic anhydride, maleimide, methylmaleimide and dienes, for example divinylbenzene, and also the particular hydroxy-functionalized and/or amino-functionalized and/or mercapto-functionalized and/or an olefinically functionalized compound. In addition, these copolymers can also be prepared in such a way that they have a hydroxyl and/or amino and/or mercapto functionality and/or an olefinic functionality in a substituent. Such monomers are, for example, vinylpiperidine, 1-vinyl-imidazole, N-vinylpyrrolidone, 2-vinylpyrrolidone, N-vinylpyrrolidine, 3-vinylpyrrolidine, N-vinylcapro-lactam, N-vinylbutyrolactam, hydrogenated vinyl-thiazoles and hydrogenated vinyloxazoles.

The process can be performed in any halogen-free solvents. Preference is given to toluene, xylene, acetates, preferably butyl acetate, ethyl acetate, propyl acetate; ketones, preferably ethyl methyl ketone, acetone; ethers; aliphatics, preferably pentane, hexane; alcohols, preferably cyclohexanol, butanol, hexanol, but also biodiesel.

Block copolymers of the AB composition may be prepared by means of sequential polymerization. Block copolymers of the ABA or ABCBA composition are prepared by means of sequential polymerization and initiation with bifunctional initiators.

The polymerization can be performed at standard pressure, reduced pressure or elevated pressure. The polymerization temperature too is uncritical. In general, it is, however, in the range of −20° C. to 200° C., preferably of 0° C. to 130° C. and more preferably of 50° C. to 120° C.

The polymers obtained in accordance with the invention preferably have a number-average molecular weight between 5000 g/mol and 120 000 g/mol, and more preferably between 7500 g/mol and 50 000 g/mol.

It has been found that the molecular weight distribution is below 1.8, preferably below 1.6, more preferably below 1.4 and ideally below 1.2.

The molecular weight distributions are determined by means of gel permeation chromatography (GPC for short).

The initiator used may be any compound which has one or more atoms or atom groups X which are free-radically transferable under the polymerization conditions of the ATRP process. The active X groups are generally Cl, Br, I, SCN and/or N₃. In general terms, suitable initiators include the following formulae:

R¹R²R³C—X,

R¹C (═O)—X,

R¹R²R³Si—X,

R¹NX₂,

R¹R²N—X, (R¹)ₙP(O)ₘ—X₃₋ₙ,

(R¹O)ₙP(O)ₘ—X₃₋ₙ

and (R¹) (R²O)P(O)ₘ—X,

where X is selected from the group consisting of Cl, Br, I, OR⁴, SR⁴, SeR⁴, OC(═O)R⁴, OP(═O)R⁴, OP(═O)(OR⁴)₂, OP(═O)OR⁴, O—N(R⁴)₂, CN, NC, SCN, NCS, OCN, CNO and N₃ (where R⁴ is an alkyl group of 1 to 20 carbon atoms, where each hydrogen atom may be replaced independently by a halogen atom, preferably fluoride or chloride, or alkenyl of 2 to 20 carbon atoms, preferably vinyl, alkenyl of 2 to 10 carbon atoms, preferably acetylenyl, phenyl which may be substituted by 1 to 5 halogen atoms or alkyl groups having 1 to 4 carbon atoms, or aralkyl, and where R¹, R² and R³ are each independently selected from the group consisting of hydrogen, halogens, alkyl groups having 1 to 20, preferably 1 to 10 and more preferably 1 to 6 carbon atoms, cycloalkyl groups having 3 to 8 carbon atoms, silyl groups, alkylsilyl groups, alkoxysilyl groups, amine groups, amide groups, COCl, OH, CN, alkenyl or alkynyl groups having 2 to 20 carbon atoms, preferably 2 to 6 carbon atoms, and more preferably allyl or vinyl, oxiranyl, glycidyl, alkenyl or alkynyl groups which have 2 to 6 carbon atoms and are substituted by oxiranyl or glycidyl, aryl, heterocyclyl, aralkyl, aralkenyl (aryl-substituted alkenyl where aryl is as defined above and alkenyl is vinyl which is substituted by one or two C₁- to C₆-alkyl groups in which one to all of the hydrogen atoms, preferably one hydrogen atom, are substituted by halogen (preferably fluorine or chlorine when one or more hydrogen atoms are replaced, and preferably fluorine, chlorine or bromine if one hydrogen atom is replaced)), alkenyl groups which have 1 to 6 carbon atoms and are substituted by 1 to 3 substituents (preferably 1) selected from the group consisting of C₁- to C₄-alkoxy, aryl, heterocyclyl, ketyl, acetyl, amine, amide, oxiranyl and glycidyl, and m=0 or 1; m=0, 1 or 2. Preferably not more than two of the R¹, R² and R³ radicals are hydrogen; more preferably, not more than one of the R¹, R² and R³ radicals is hydrogen.

The particularly preferred initiators include benzyl halides such as p-chloromethylstyrene, hexakis(α-bromomethyl)benzene, benzyl chloride, benzyl bromide, 1-bromo-i-phenylethane and 1-chloro-i-phenylethane. Particular preference is further given to carboxylic acid derivatives which are halogenated at the α-position, for example propyl 2-bromopropionate, methyl 2-chloropropionate, ethyl 2-chloropropionate, methyl 2-bromopropionate or ethyl 2-bromoisobutyrate. Preference is also given to tosyl halides such as p-toluenesulphonyl chloride; alkyl halides such as tetrachloromethane, tribromoethane, 1-vinylethyl chloride or 1-vinylethyl bromide; and halogen derivatives of phosphoric esters such as dimethylphosphonyl chloride.

A particular group of initiators suitable for the synthesis of block copolymers is that of the macroinitiators. These feature macromolecular radicals in 1 to 3 radicals, preferably 1 to 2 radicals, and more preferably in 1 radical from the group of R¹, R² and R³. These macroradicals may be selected from the group of the polyolefins such as polyethylenes or polypropylenes; polysiloxanes; polyethers such as polyethylene oxide or polypropylene oxide; polyesters such as polylactic acid or other known end group-functionalizable macromolecules. The macromolecular radicals may each have a molecular weight between 500 and 100 000, preferably between 1000 and 50 000 and more preferably between 1500 and 20 000. To initiate the ATRP, it is also possible to use said macromolecules which have groups suitable as an initiator at both ends, for example in the form of a bromotelechelic. With macroinitiators of this type, it is possible in particular to form ABA triblock copolymers.

A further important group of initiators is that of the bi- or multifunctional initiators. With multifunctional initiator molecules, it is possible, for example, to synthesize star polymers. With bifunctional initiator molecules, it is possible to prepare tri- and pentablock copolymers and telechelic polymers. The bifunctional initiators used may be RO₂C—CHX—(CH₂)ₙ—CHX—CO₂R, RO₂C—C (CH₃)X—(CH₂)ₙ—C(CH₃)X—CO₂R, RO₂C—CX₂—(CH₂)ₙ-CX₂—CO₂R, RC(O)—CHX—(CH₂)ₙ—CHX—C(O)R, RC(O)—C(CH₃)X—(CH₂)ₙ—C(CH)₃X—C(O)R, RC(O)—CX₂—(CH₂)ₙ—CX₂—C(O)R, XCH₂—CO₂—(CH₂)ₙ—OC(O) CH₂X, CH₃CHX—CO₂—(CH₂)ₙ—OC(O) CHXCH₃, (CH₃)₂CX—CO₂—(CH₂)ₙ—OC(O)CX(CH₃)₂, X₂CH—CO₂—(CH₂)ₙ—OC(O)CHX₂, CH₃CX₂—CO₂—(CH₂)ₙ—OC(O)CX₂CH₃, XCH₂C(O)C(O) CH₂X, CH₃CHXC(O)C(O) CHXCH₃, XC(CH₃)₂C(O)C(O)CX(CH₃)₂, X₂CHC(O)C(O)CHX₂, CH₃CX₂C(O)C(O)CX₂CH₃, XCH₂—C(O)—CH₂X, CH₃—CHX—C(O)—CHX—CH₃, CX(CH₃)₂—C(O)—CX(CH₃)₂, X₂CH—C(O)—CHX₂, C₆H₅—CHX—(CH₂)ₙ—CHX—C₆H₅, C₆H₅—CX₂—(CH₂)—CX₂—C₆H₅, C₆H₅—CX₂(CH₂)ₙ—CX₂—C₆H₅, o, -m- or p-XCH₂-Ph-CH₂X, o, -m- or p-CH₃CHX-Ph-CHXCH₃, o, -m- or p-(CH₃)₂CX-Ph-CX(CH₃)₂, o, -m- or p-CH₃CX₂-Ph-CX₂CH₃, o, -m- or p-X₂CH-Ph-CHX₂, o, -m- or p-XCH₂-CO₂-Ph-OC(0)CH₂X, o, -m- or p-CH₃CHX-CO₂-Ph-OC(O)CHXCH₃, o, -m- or p-(CH₃)₂CX—CO₂-Ph-OC(O)CX(CH₃)₂, CH₃CX₂—CO₂-Ph-OC(O)CX₂CH₃, o, -m- or p- X₂CH—CO₂-Ph-OC(O)CHX₂ or o, -m- or p-XSO₂-Ph-SO₂X (X is chlorine, bromine or iodine; Ph is phenylene (C₆H₄); R represents an aliphatic radical of 1 to 20 carbon atoms which may be of linear, branched or else cyclic structure, may be saturated or mono- or polyunsaturated and may contain one or more aromatics or is aromatic-free, and n is from 0 to 20). Preference is given to using 1,4-butanediol di(2-bromo-2-methylpropionate), 1,2-ethylene glycol di(2-bromo-2-methylpropionate), diethyl 2,5-dibromoadipate or diethyl 2,3-dibromomaleate. If all of the monomer used is converted, the later molecular weight is determined from the ratio of initiator to monomer.

Catalysts for ATRP are detailed in Chem. Rev. 2001, 101, 2921. Predominantly copper complexes are described—other compounds also used include those of iron, cobalt, chromium, manganese, molybdenum, silver, zinc, palladium, rhodium, platinum, ruthenium, iridium, ytterbium, samarium, rhenium and/or nickel. In general, it is possible to use all transition metal compounds which can form a redox cycle with the initiator or the polymer chain which has a transferable atom group. For this purpose, copper can be supplied to the system, for example, starting from Cu₂O, CuBr, CuCl, CuI, CuN₃, CuSCN, CuCN, CuNO₂, CuNO₃, CuBF₄, Cu(CH₃COO) or Cu(CF₃COO).

One alternative to the ATRP described is a variant thereof: in so-called reverse ATRP, it is possible to use compounds in higher oxidation states, for example CuBr₂, CuCl₂, CuO, CrCl₃, Fe₂O₃ or FeBr₃. In these cases, the reaction can be initiated with the aid of classical free-radical formers, for example AIBN. This initially reduces the transition metal compounds, since they are reacted with the free radicals obtained from the classical free-radical formers. Reverse ATRP has also been described, inter alia, by Wang and Matyjaszewski in Macromolecules (1995), Vol. 28, p. 7572 ff.

A variant of reverse ATRP is that of the additional use of metals in the zero oxidation state. Assumed comproportionation with the transition metal compounds of the higher oxidation state brings about acceleration of the reaction rate. This process is described in detail in WO 98/40415.

The molar ratio of transition metal to monofunctional initiator is generally within the range of 0.01:1 to 10:1, preferably within the range of 0.1:1 to 3:1 and more preferably within the range of 0.5:1 to 2:1, without any intention that this should impose a restriction.

The molar ratio of transition metal to bifunctional initiator is generally within the range of 0.02:1 to 20:1, preferably within the range of 0.2:1 to 6:1 and more preferably within the range of 1:1 to 4:1, without any intention that this should impose a restriction.

In order to increase the solubility of the metals in organic solvents and simultaneously to avoid the formation of stable and hence polymerization-inactive organometallic compounds, ligands are added to the system. In addition, the ligands ease the abstraction of the transferable atom group by the transition metal compound. A list of known ligands can be found, for example, in WO 97/18247, WO 97/47661 or WO 98/40415. As a coordinative constituent, the compounds used as a ligand usually have one or more nitrogen, oxygen, phosphorus and/or sulphur atoms. Particular preference is given in this context to nitrogen compounds. Very particular preference is given to nitrogen-containing chelate ligands. Examples include 2,2′-bipyridine, N,N,N′,N″,N″-pentamethyldiethylenetriamine (PMDETA), tris(2-aminoethyl)amine (TREN), N,N,N′,N′-tetramethylethylenediamine or 1,1,4,7,10,10-hexamethyltriethylenetetramine. Valuable information on the selection and combination of the individual components can be found by the person skilled in the art in WO 98/40415.

These ligands can form coordination compounds with the metal compounds in situ or they can be prepared initially as coordination compounds and then be added to the reaction mixture.

The ratio of ligand (L) to transition metal is dependent upon the denticity of the ligand and the coordination number of the transition metal (M). In general, the molar ratio is in the range of 100:1 to 0.1:1, preferably 6:1 to 0.1:1 and more preferably 3:1 to 1:1, without any intention that this should impose a restriction.

What is crucial for the present invention is that the ligands are protonatable.

Preference is given to ligands which are present in the coordination compound in a ratio of 1:1 relative to the transition metal. When ligands such as 2,2′-bipyridine are used, which are bound within the complex in a ratio relative to the transition metal of 2:1, complete protonation can be effected only when the transition metal is used in a significant deficiency, of for example, 1:2 relative to the active chain end X. However, such a polymerization would be greatly slowed compared to one with equivalent complex-X ratios.

For the inventive silyl-functionalized products, there is a broad field of application. The selection of the use examples is not capable of restricting the use of the inventive polymers. The examples shall serve solely to indicate the wide range of possible uses of the polymers described by way of random sample. For example, polymers synthesized by means of ATRP are used as binders in formulations for hotmelts, adhesives, elastic adhesives, sealant materials, heat-sealing materials, rigid or flexible foams, paints or varnishes, moulding materials, casting materials, floor coverings or in packagings. They may also find use as dispersants, as a polymer additive or as prepolymers for polymer-analogous reactions or for the formation of block copolymers. It is preferably possible to produce adhesives and sealants with the new binders.

These new binders may be used in both one-component and two-component formulations. In two-component systems, for example, coformulation with silylated polyurethanes is conceivable.

Further customary constituents of such formulations are, as well as the binders, solvents, fillers, pigments, plasticizers, stabilizing additives, water scavengers, adhesion promoters, thixotropic agents, crosslinking catalysts, tackifiers and further constituents known to those skilled in the art.

The examples given below are given for better illustration of the present invention but are not capable of restricting the invention to the features disclosed herein.

### EXAMPLES

The present examples were based on the ATRP process. The polymerization parameters were selected such that it was necessary to work with particularly high copper concentrations: low molecular weight, 50% solution and bifunctional initiator.

### Example 1

A jacketed vessel equipped with stirrer, thermometer, reflux condenser, nitrogen inlet tube and dropping funnel was initially charged under N₂ atmosphere with 10 g of methyl methacrylate, 15.8 g of butyl acetate, 0.2 g of copper(I) oxide and 0.5 g of PMDETA. The solution is stirred at 60° C. for 15 min. Subsequently, at the same temperature, 0.47 g of 1,4-butanediol di(2-bromo-2-methylpropionate) is added. The mixture is stirred at 70° C. for a polymerization time of 4 hours. After introducing atmospheric oxygen for approx. 5 min to terminate the reaction, 0.25 g of 3-mercaptopropyl-trimethoxysilane is added. The solution which was greenish beforehand spontaneously turns reddish, and a red solid precipitates out. The filtration is effected by means of an elevated pressure filtration. The mean molecular weight and the molecular weight distribution are subsequently determined by GPC measurements. The copper content of a dried sample of the filtrate is subsequently determined by means of AAS.

The remaining solution is admixed with 8 g of Tonsil Optimum 210FF (from Sudchemie), stirred for 30 min and subsequently filtered through an activated carbon filter (AKS 5 from Pall Seitz Schenk) under elevated pressure. Beforehand, the formation of a colourless precipitate could be observed. For further analysis, a sample of this solid is isolated. The copper content of a dried sample of the second filtrate is also determined by means of AAS, and a GPC measurement is undertaken.

### Example 2

A jacketed vessel equipped with stirrer, thermometer, reflux condenser, nitrogen inlet tube and dropping funnel was initially charged under N₂ atmosphere with 7.5 g of methyl methacrylate, 15.8 g of butyl acetate, 0.2 g of copper(I) oxide and 0.5 g of PMDETA. The solution is stirred at 60° C. for 15 min. Subsequently, at the same temperature, 0.47 g of 1,4-butanediol di(2-bromo-2-methylpropionate) is added. The mixture is stirred at 70° C. for a polymerization time of 2.5 hours and then a sample is taken for GPC measurement. Thereafter, 2.5 g of n-butyl acrylate are added and the mixture is stirred at 70° C. for a further 90 min. After introducing atmospheric oxygen for approx. 5 min to terminate the reaction, 0.25 g of 3-mercaptopropyltrimethoxysilane is added. The solution which was greenish beforehand spontaneously turns reddish, and a red solid precipitates out. The filtration is effected by means of an elevated pressure filtration. The mean molecular weight and the molecular weight distribution are subsequently determined by GPC measurements. The copper content of a dried sample of the filtrate is subsequently determined by means of AAS.

The remaining solution is admixed with 8 g of Tonsil Optimum 210FF (from Sudchemie), stirred for 30 min and subsequently filtered through an activated carbon filter (AKS 5 from Pall Seitz Schenk) under elevated pressure. Beforehand, the formation of a colourless precipitate could be observed. For further analysis, a sample of this solid is isolated. The copper content of a dried sample of the second filtrate is also determined by means of AAS, and a GPC measurement is undertaken.

### Comparative Example 1

A jacketed vessel equipped with stirrer, thermometer, reflux condenser, nitrogen inlet tube and dropping funnel was initially charged under N₂ atmosphere with 10 g of methyl methacrylate, 15.8 g of butyl acetate, 0.2 g of copper(I) oxide and 0.5 g of PMDETA. The solution is stirred at 60° C. for 15 min. Subsequently, at the same temperature, 0.47 g of 1,4-butanediol di(2-bromo-2-methylpropionate) is added. The mixture is stirred at 70° C. for a polymerization time of 4 hours. After introducing atmospheric oxygen for approx. 5 min to terminate the reaction, 8 g of Tonsil Optimum 210 FF (from Sudchemie) and 4% by weight of water are added to the solution and stirred for 60 min. The filtration is effected by means of an elevated pressure filtration through an activated carbon filter (AKS 5 from Pall Seitz Schenk). The mean molecular weight and the molecular weight distribution are subsequently determined by GPC measurements. The copper content of a dried sample of the filtrate is subsequently determined by means of AAS.

TABLE 1

| Example | Example 1 | Example 2 | Comparative 1 |
|---|---|---|---|
| Monomer | MMA | MMA/n-BA | MMA |
| Cu concentration | approx. 5.5 mg/g | | |
| (polymerization) | | | |
| Sulphur compound | 3-mercaptopropyltri- | | — |
| | methoxysilane | | |
| Adsorbent | — | — | alox/silica |
| Cu concentration | 0.2 μg/g | 0.3 μg/g | 20 μg/g |
| (2nd filtration) | | | |
| Equivalents | 1.27 | 1.27 | — |
| relative to Cu | | | |
| Mₙ | — | 6900 | — |
| (first stage) | | | |
| M_{w}/Mₙ | — | 1.19 | — |
| (first stage) | | | |
| Mₙ | 8200 | 8500 | 8800 |
| (before | | | |
| purification) | | | |
| M_{w}/Mₙ | 1.21 | 1.17 | 1.20 |
| (before | | | |
| purification) | | | |
| Mₙ | 8200 | 8600 | 8900 |
| (after | | | |
| purification) | | | |
| M_{w}/Mₙ | 1.31 | 1.18 | 1.21 |
| (after | (dimerization) | | |
| purification) | | | |

MMA = methyl methacrylate;
alox = aluminium oxide

It is clearly evident from the examples that the already very good results with adsorbents to remove transition metal complexes (in this case copper complexes) from polymer solutions can be clearly improved by the preceding precipitation with sulphur compounds.

The end group substitution is proved in several ways by characterizing various constituents of the worked-up polymer solution:

1.) The copper precipitate: the red precipitate which forms on addition of the sulphur reagents exhibits, at <10 ppm, an extremely low sulphur content, so that precipitation of the metal as the sulphide can be ruled out.

2.) The polymer: the elemental analysis of the polymer solution exhibits, even after removal of the second, colourless precipitate, a very high sulphur content. Virtually all of the sulphur added to the system is found again in the solution or in the dried product. This corresponds to 65% of the sulphur content used or approx. 90% of the sulphur content which would have been expected in the case of a theoretical complete end group substitution with complete avoidance of preceding termination reactions.

3.) The second, colourless precipitate: both ¹H NMR analyses and IR spectroscopy showed that the precipitate is the ammonium salt of the monoprotonated triamine PMDETA. An elemental analysis showed that this precipitate is sulphur-free. By means of ion chromatography, it was possible, according to the sample, to detect a bromide content between 32% by weight and 37% by weight. This value corresponds to the content in a pure PMDETA ammonium bromide.

4.) In the NMR analysis, a shift of the methylene protons present in the a-position to the original thiol group was detectable. This is a clear indication to the formation of a thioether group.

It is evident from the results for Example 1 that corresponding sulphur compounds, based on the transition metal compound, even used in an ultrasmall excess, lead to very efficient precipitation and a high degree of functionalization. It is also evident from the examples that it is possible with thiol-functionalized reagents to realize more efficient removal of the transition metal compounds from the solution that is possible through an already optimized workup with adsorbents.

It is evident from the comparison of the molecular weights and molecular weight distributions before and after the workup that the methods employed, with the exception of the substitution of the end groups, have no influence on the polymer characteristics. In Example 2, an additional high molecular weight signal was detectable in the GPC measurement. This is attributable to dimerization of chains to form Si—O—Si bonds and is a further indication of successful substitution. Under dry storage conditions, such a dimerization is avoidable.

1: A process for preparing polymers with silyl end groups, characterized in that halogen atoms at polymer chain ends are substituted by means of an addition of a suitable silyl-functionalized sulphur compound.

2: The process for preparing polymers with silyl end groups according to claim 1, characterized in that transition metal compounds are removed from polymer solutions by precipitating the transition metal compound by means of addition of a sulphur compound and then removing it by means of filtration.

3: The process for preparing polymers with silyl end groups according to claim 1, characterized in that halogen atoms are removed simultaneously from polymers by substituting the halogen atoms to an extent of more than 90% by the addition of the sulphur compound.

4: The process for preparing polymers with silyl end groups according to claim 3, characterized in that halogen atoms are removed simultaneously from polymers by substituting the halogen atoms to an extent of more than 95% by the addition of the sulphur compound.

5: The process for preparing polymers with silyl end groups according to claim 2, characterized in that the halogen atom substitution, the transition metal compound removal and the filtration process steps proceed simultaneously.

6: The process for preparing polymers with silyl end groups according to claim 5, characterized in that the sulphur compound is a mercaptan or another organic compound having a thiol group.

7: The process for preparing polymers with silyl end groups according to claim 6, characterized in that said sulphur compound has an additional functionality.

8: The process for preparing polymers with silyl end groups according to claim 7, characterized in that the further functionality is a silyl end group.

9: The process for preparing polymers with silyl end groups according to claim 8, characterized in that the sulphur compounds are silyl-functionalized mercaptans of the formula
HS—R¹—((SiR²ₒ(OR³)ₚ)_{y}(SiR²ₙ(OR³)ₘ)_{z})ₓ
where:
R¹ is an alkyl radical having one to 20 carbon atoms,
x is from 1 to 10,
R² and R are each alkyl radicals having one to 20 carbon atoms,
o and p each mean numbers from 0 to 2, which add up to 2 in the case of a divalent silyl group, add up to 1 in the case of a trivalent silyl group and add up to 0 in the case of a tetravalent silyl group,
y is any number from 0 to 20,
z depends on the number of tri- or tetravalent, i.e. branching, silyl groups between R¹ and the end groups and is at least 1, and where m and n are each from 0 to 3, and add up to 3.

10: The process for preparing polymers with silyl end groups according to claim 8, characterized in that the sulphur compounds are silyl-functionalized mercaptans of the formula
HS—R¹—((SiRₒ²(OR³)ₚ)_{y}(SiRₙ²(OR³)ₘ))ₓ
where:
R¹ is an alkyl radical having one to 10 carbon atoms,
x is from 1 to 3,
R² and R³ are each linear alkyl radicals having one to 10 carbon atoms, o and p each mean numbers from 0 to 2 which add up to 2 in the case of a divalent silyl group, add up to 1 in the case of a trivalent silyl group and add up to 0 in the case of a tetravalent silyl group,
y is from 0 to 3,
and m and n are each numbers from 0 to 3,
where m is 2 or 3.

11: The process for preparing polymers with silyl end groups according to claim 8, characterized in that the sulphur compounds are silyl-functionalized mercaptans of the formula
HS—R¹—(SiRₙ²(OR³)ₘ)ₓ
where:
R is —CH₂—, —CH₂CH₂— or —(CH₂)₃—,
x is 1,
R² and R³ are ach methyl and/or ethyl groups,
and m and n each mean numbers from 0 to 3,
where m is 2 or 3.

12: The process for preparing polymers with silyl end groups according to claim 11, characterized in that the sulphur compound is mercaptomethylmethyldiethoxy-silane, 3-mercaptopropyltrimethoxysilane, 3-mercaptopropyltriethoxysilane or 3-mercaptopropylmethyl-dimethoxysilane.

13: The process for preparing polymers with silyl end groups according to claim 1, characterized in that the sulphur compound is added after or during the termination of a polymerization.

14: The process for preparing polymers with silyl end groups according to claim 1, characterized in that the polymerization is by the ATRP process.

15: The process according to claim 14, characterized in that the transition metal compound used as a catalyst in the polymerization is a copper, iron, cobalt, chromium, manganese, molybdenum, silver, zinc, palladium, rhodium, platinum, ruthenium, iridium, ytterbium, samarium, rhenium and/or nickel compound.

16: The process according to claim 15, characterized in that the transition metal used as a catalyst in the polymerization is a copper compound.

17: The process according to claim 16, characterized in that the copper compound, as Cu₂O, CuBr, CuCl, Cul, CuN₃, CuSCN, CuCN, CUNO₂, CuNO₃, CuBF₄, Cu(CH₃COO) and/or Cu(CF₃COO), has been added to the system before the start of the polymerization.

18: The process according to claim 14, characterized in that an initiator which has an active group X is used in the preceding polymerization.

19: The process according to claim 18, characterized in that the active X group is Cl, Br, I, SCN and/or N₃.

20: The process according to claim 19, characterized in that the initiator may be mono-, di- or polyfunctional with regard to the active groups.

21: The process according to claim 18, characterized in that the active X group on the chain ends of the polymers is substituted by a suitable silyl-functionalized sulphur compound to give a thioether with release of an acid of the form X—H.

22: The process according to claim 15, characterized in that the catalyst is combined before the polymerization with a nitrogen, oxygen, sulphur or phosphorus compound which can enter into one or more coordinate bonds with the transition metal to give a metal-ligand complex.

23: The process according to claim 22, characterized in that the ligands are N-containing chelate ligands.

24: The process according to claim 23, characterized in that the ligand is protonated by the acid X—H.

25: The process according to claim 24, characterized in that the ligand is removed from the coordinated transition metal by the protonation.

26: The process according to claim 25, characterized in that the transition metal is precipitated by the removal of the ligand.

27: The process according to claim 26, characterized in that the metal content in the polymer solution decreases by at least 80% as a result of the precipitation and the subsequent filtration.

28: The process according to claim 27, characterized in that the metal content in the polymer solution decreases by at least 95% as a result of the precipitation and the subsequent filtration.

29: The process according to one of the claim 1, characterized in that the polymers are produced by polymerizing alkyl acrylates, alkyl methacrylates, styrenes, vinyl esters, vinyl ethers, fumarates, maleates, itaconates, acrylonitriles and/or other monomers polymerizable by means of ATRP and/or mixtures of alkyl acrylates, alkyl methacrylates, vinyl esters, vinyl ethers, fumarates, maleates, itaconates, styrenes, acrylonitriles, and/or other monomers polymerizable by means of ATRP.

30: The process according to claim 29, characterized in that the polymers are obtainable by polymerizing styrenes, alkyl acrylates and/or alkyl methacrylates and/or mixtures which consist predominantly of styrenes, alkyl acrylates and/or alkyl methacrylates.

31: Polymers prepared by the process according to claim 1, characterized in that they have been prepared by means of ATRP, have a molecular weight distribution of less than 1.5, have a halogen content of less than 0.1% by weight and have at least one silyl group on one of the chain ends.

32: Linear polymers according to claim 31, characterized in that they have been prepared with a bifunctional initiator, have a halogen content of less than 0.1% by weight and have silyl groups on both chain ends.

33: Linear polymers according to claim 32, characterized in that they have been prepared with a bifunctional initiator, have a halogen content of less than 0.01% by weight and have silyl groups on both chain ends.

34: Linear polymers according to claim 33, characterized in that they have been prepared with a bifunctional initiator, have a halogen content of less than 0.01% by weight, have an ABA triblock structure and have silyl groups on both chain ends.

35: Hotmelts, adhesives, sealant materials, heat-sealing materials, rigid or flexible foams, polymer-analogous reactants cosmetic applications, paints or varnishes, moulding materials, casting materials, floor coverings, dispersants, polymer additives and packagings comprising the silyl-telechelic polymers prepared by the process according to claim 1.
